(19) United States
(12) Patent Application Publication
(10) Pub. No.: US 2004/0078914 A1
(43) Pub. Date: Apr. 29, 2004

(54) Clean swipe

(76) Inventor: Patrick Lee Wayne Walker, Prescott, AZ (US)

Correspondence Address: Patrick Lee Wayne Walker, 611 Delano Ave., Prescott, AZ, 86301, US

(21) Appl. No.: 10/356,159

(22) Filed: Jan. 31, 2003

Related U.S. Application Data
(60) Provisional application No. 60/352,904, filed on Jan. 31, 2002.

(51) Int. Cl. G01F 15/12

(52) U.S. Cl. 15/220.4

(57) ABSTRACT

Having a Clean Swipe on your automobile or recreational vehicle will allow you to check your oil level like never before. Not only is its operation cleaner but also faster and with less hassle. The Clean Swipe will forever change the way we check our oil levels.

The Clean Swipe invention will eliminate the hassle when checking your automobile oil level. You will no longer have to use an oily rag from under your hood, or have to look for a paper towel ever again. The convenience of a Clean Swipe will always be there for you.

To install, simply pull your dipstick out of the dipstick shaft. Then slide the Clean Swipe down on the dipstick shaft to its proper position. Then put the dipstick back into the shaft. Now you are ready to get an accurate oil reading without the mess.

To do this, compress the Clean Swipe with your thumb and index finger. With your other hand, slide the dipstick out of the shaft. You have just cleaned your dipstick. Then release the Clean Swipe and put the dipstick back in the shaft. Pull the dipstick out once more. You now have an accurate oil reading on your dipstick.

Materials used to make the Clean Swipe.

A flexible rubber that is also durable.

Flexible, so it can be compressed and also stretched.

Durable, so it can withstand moderate heat and sustain lasting life.

The inner area of the swipe will contain an absorbing sponge material, which will also compress along with swipe.

I, Patrick Lee Wayne Walker, claim the benefit of my invention, “the clean swipe”:

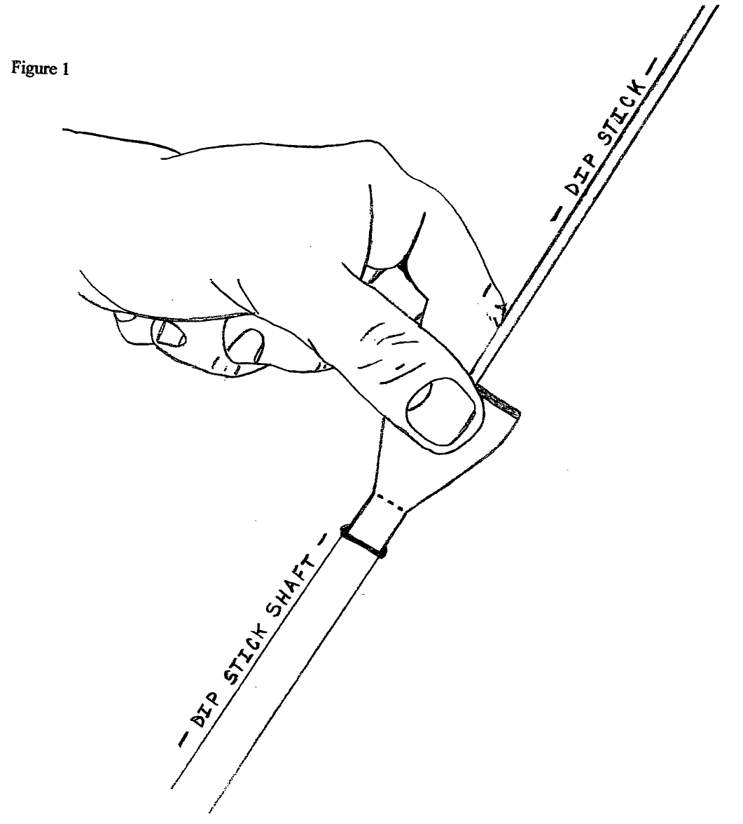

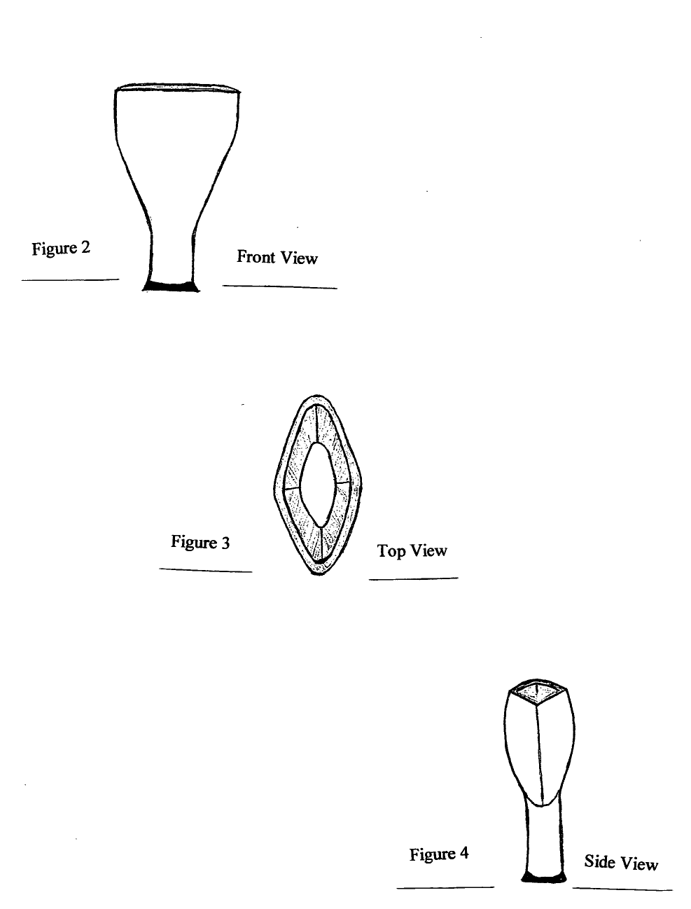

1. The Clean Swipe will enable clean and easy oil readings. See FIG. 1 drawing.

2. The materials to produce the Clean Swipe will consist of soft rubber and an absorbing sponge material.

3. The Clean Swipe should be attached far enough down the dipstick shaft to allow the dipstick cover and handle to meet the shaft. This will enable an accurate oil reading.

4. The model in FIG. 1 will be used on short dipstick shafts.

5. The inner sponge liner used in the FIG. 1 model could be made to be replaced.

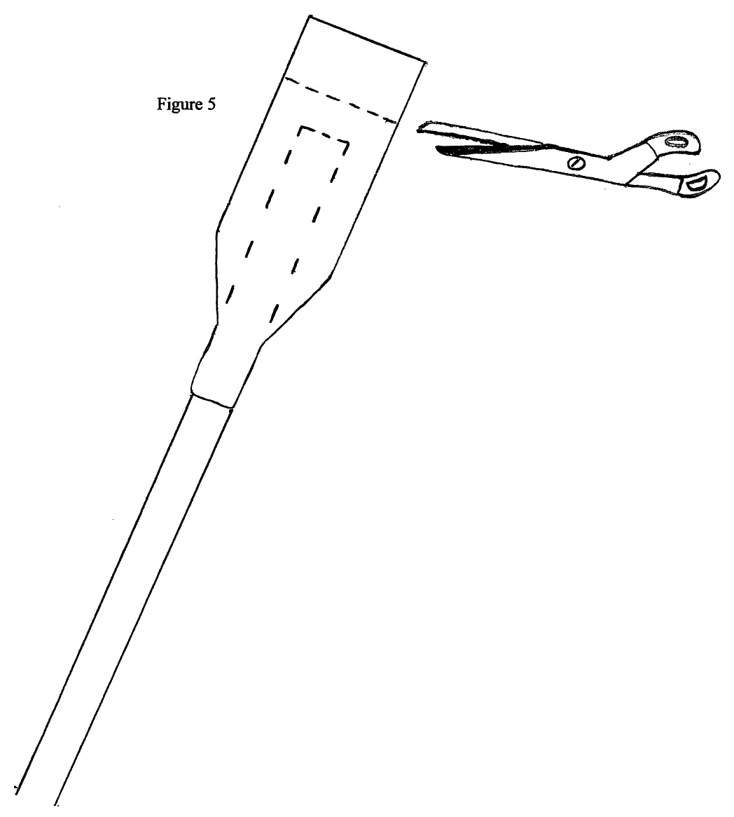

6. The example in the FIG. 5 model is constructed longer above the base.

7. This model in FIG. 5 will be used on longer dipstick shafts.

8. Constructing the Clean Swipe longer will allow you to cut off the oily end of the swipe after many uses. Then the swipe could be pulled further up the shaft to its proper position for further cleanings.
